(19) United States
(12) Patent Application Publication
(10) Pub. No.: US 2011/0157539 A1
(43) Pub. Date: Jun. 30, 2011

(54) SECURITY ELEMENT HAVING A VARIABLE OPTICAL EFFECT AND SECURITY SHEET OR DOCUMENT OR ARTICLE COMPRISING IT

(75) Inventor: Henri Rosset, Le Pin (FR)

(73) Assignee: ARJOWIGGINS SECURITY, PARIS (FR)

(21) Appl. No.: 13/001,220

(22) PCT Filed: Jul. 2, 2009
(86) PCT No.: PCT/FR09/51290

§ 371 Date: Feb. 28, 2011

(30) Foreign Application Priority Data
Jul. 3, 2008 (FR) 0803772

(51) Int. Cl. G02F 1/13; B42D 15/00

(52) U.S. Cl. 349/193; 283/85; 283/74

(57) ABSTRACT

A security element having a variable optical effect, including at least one quasi-spherical particle having at least one external part and at least one internal part, said external part including at least one cholesteric liquid crystal and said internal part including at least one thermochromic compound and/or at least one photochromic compound undergoing a reversible transition from a colourless state to a dark colour or from a dark colour to a colourless state when said compound is subjected to an activation temperature or to activation radiation respectively, the dark colour making it possible to see the interference effect of said liquid crystal, and the colourless state making this interference effect no longer visible.

The invention relates to an interactive optically variable security element and to security sheets and documents or articles including said element.

The security documents may for example be bank bills, identity cards, passports, driving licenses, visas, checks, goods of value, tickets for travel or tickets for entrance to a cultural or sporting event, tickets for games. They are especially produced from, fibrous materials, and include security elements allowing them to be authenticated, especially elements that allow authentication with the naked eye (optionally using a magnifying glass) or using a portable instrument.

Patent application EP-A-0608078 has described security elements, in particular threads, which have thermochromic properties, placed in security documents. Thermochromic materials are well known: they have the ability to change reversibly from one color to another, often from colorless to colored or the reverse, at a given activation temperature. These elements are formed from a plastic support bearing marks, such as imprints, on which (or on the opposite side of which) a thermochromic layer, made of an ink comprising thermochromic compounds, is applied. These elements are incorporated into a document and appear in windows on the surface of said document. When the thermochromic compounds change from a colored state to a colorless state, by increasing the temperature, the marks may be seen or, conversely, when the thermochromic compounds change from being colorless to being colored, by decreasing the temperature, the marks may no longer be seen—this allows the document to be authenticated.

Patent application EP-A-1161352 has also described security elements, in particular threads, which have thermochromic properties, placed in security documents. These elements include a first transparent layer (a support film made of polyester for example) one side of which is coated with an optically variable ink (OVI) and the other side of which bears indicia on which a thermochromic layer is applied. The optically variable ink produces an interference effect created by opaque microparticles. When the thermochromic layer is colored, the indicia are not visible but the optical interference effect is observed and when the thermochromic layer is colorless, the indicia are visible but the optical interference effect disappears.

U.S. Pat. No. 7,316,422 B1 has also described security elements, including a thermochromic layer for authenticating an object, said element being then placed on the surface of the object so that it may be observed. This element includes, in combination with the thermochromic layer, special layers with properties than can be detected visually or using an instrument, such as optical layers comprising iridescent pigments or liquid crystals or even a luminescent or magnetic layer.

One drawback of this prior art is that it is necessary to manufacture the security elements by applying a plurality of layers in succession, which may require the use of a multiple-unit coating device and call for a long production time (drying time between layers for example). In addition, this may limit the final application of these elements to materials in sheet form.

A first aim of the invention is to solve the drawbacks of the prior art and to provide an optically variable security element which is easy to use and does not require many successive applications of layers when employed.

A second aim is to provide novel security elements so as to increase or renew the security of documents, especially those possibly having various optical effects.

For this purpose, the invention provides an optically variable security element which is characterized in that it comprises at least one quasi-spherical particle which includes at least one external part and at least one internal part, said external part including at least one cholesteric liquid crystal and said internal part including at least one thermochromic compound and/or a photochromic compound that undergoes a reversible transition from a colorless state to a dark color or from a dark color to a colorless state when said compound is subjected, respectively, to an activation temperature or activation radiation, the dark color making it possible to see the interference effect of said liquid crystal and the colorless state making this interference effect no longer visible.

Cholesteric liquid crystals are transparent and their interference effect (change from one color or hue to another depending on the viewing angle or angle of illumination) is clearly revealed only when they are observed against a dark background.

The term “colorless” is understood to mean a low-intensity translucent colored state, even a perfectly colorless transparent state, that may be seen through and that does not reveal the interference effect (color change) of said liquid crystals.

The term “dark color” is understood to mean a sufficiently dark, even perfectly black, opaque colored state that may not be seen through and that reveals the interference effect of the liquid crystals.

More specifically, so as to observe the interference effect of the liquid crystals, the dark color of the thermochromic or photochromic compound preferably has a lightness L* of 37 or less, determined according to the CIE system under illuminant D65 (daylight without UV) and at a viewing angle of 10 degrees—measurement made using an Elrepho 2000 spectrophotometer.

By thus combining, within a single particle, such liquid crystals and, for example, thermochromic compounds that are black at room temperature and that allow the interference effect of the liquid crystal to be observed, this interference effect is made, to disappear by touching the security element, with the hand for example, the body's heat causing the thermochromic compounds to change to their colorless state. If a hidden message is placed beneath the element, it is then possible to reveal it when the thermochromic compounds change to the colorless state. It is also possible to combine other visual effects (luminescence (fluorescence, phosphorescence) and other interference effects) within a given particle but also by mixing different sorts of particle as described later on. One of the advantages of the invention is therefore that it provides a large number of combinations allowing the creation of varied and complex visual effects, without requiring the application of a plurality of layers onto a plastic support, for example to make a security thread.

Furthermore, depositing the thermochromic and/or photochromic compound or compounds in the quasi-spherical particle, and especially in an internal part of the quasi-spherical particle, may advantageously allow this compound or these compounds to be protected, which compounds may be sensitive to aging and to prolonged exposure to light for example, meaning that the magnitude of the associated effects decreases with time.

As cholesteric liquid crystals it is possible to use crystals in the form of flakes based on highly crosslinked crystalline organic polymers, sold under the Helicone® trade name by SICPA. Liquid crystals are provided in this range having as an interference effect, in each family of crystals, for example the transition from copper red to green, from gold to green, from green to blue, from turquoise to dark blue and from titanium gray to blue-green. For certain liquid crystals the transition from one color to another is very sharp (called a flip-flop effect). In addition, observation of the color change may require a polarizing filter in certain cases.

As thermochromic compounds it is possible to use compounds in the Chromazone® range sold by Lamberti, or those in the Chromicolor® Aqualite range sold by Matsui or even those notably in the form of thermochromic capsules sold by the French company Gem'innov.

More particularly according to the invention, said thermochromic compound has an activation temperature above 25° C., preferably between 25 and 40° C., and is chosen from thermochromic compounds that are a dark color at a temperature below said activation temperature and that are colorless at a temperature above this activation temperature and from thermochromic compounds that are colorless at a temperature below said activation temperature and that are a dark color at a temperature above this activation temperature.

Also more particularly according to the invention, said photochromic compound is chosen from photochromic compounds that are colorless in UV-free light and a dark color under specific activation radiation, in particular ultraviolet (UV) radiation.

The expression “light with no ultraviolet component” is understood to mean that said light does not comprise sufficient UV radiation to cause the photochromic compound to change to a dark color state: it is possible therefore for the light nevertheless to contain a small amount of UV, but insufficient to activate the photochromic compound however. For example, the photochromic compound will be colored if it is observed in daylight but colorless behind glazing or in a room lit for example by conventional incandescent interior lighting. To activate the photochromic compound in its dark colored state, the light must contain sufficient UV (for example direct (solar) daylight or a UV source).

As photochromic compounds it is possible to use those in the Photopia® range sold by Matsui or photochromic capsules sold by Gem'innov.

The quasi-spherical particles according to the invention may be particles formed from a fluidized bed making it possible to create layers in succession or capsules. Their average size depends on the application and on the optical combinations desired—it is preferably between 1 and 20 μm, more particularly between 3 and 10 μm.

As quasi-spherical particles it is possible to use capsules having various structures, as will be explained in greater detail in the following description of the invention, using the appended figures by way of example.

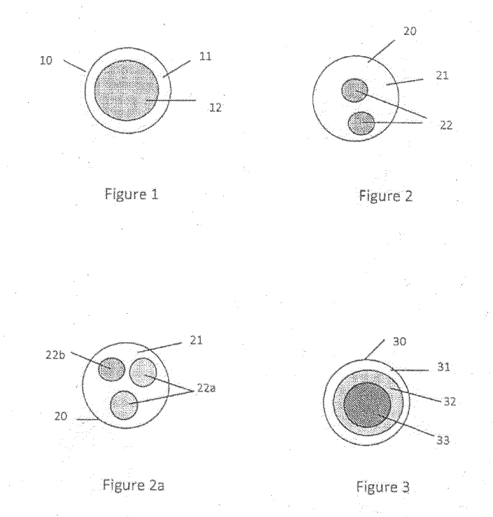

FIG. 1 shows a view in cross section of a single-core capsule 10 comprising a wall 11 and an encapsulated core 12.

FIG. 2 shows a view in cross section of a multicore capsule comprising a wall 21 and more than one encapsulated core 22.

FIG. 2a shows a view in cross section of a multicore capsule 20 comprising a wall 21 and two encapsulated cores 22a and 22b.

FIG. 3 shows a view in cross section of a capsule 30 comprising three concentric layers, an external layer 31 and two internal layers 32 and 33 that may correspond either to a dual-walled capsule with an external wall 31, an internal wall 32 and an encapsulated core 33 or to a dual-core capsule that comprises a wall 31 and a core 32 surrounding another core 33.

According to a particular embodiment of the invention, with reference to FIG. 1, said capsule is a single-core capsule 10 comprising a wall 11 and an encapsulated core 12, said external part including said cholesteric liquid crystal being the wall 11, and said internal part including said thermochromic compound or said photochromic compound being the encapsulated core 12.

According to another particular embodiment of the invention, with reference to FIG. 2, the capsule is a multicore capsule 20 comprising a wall 21 and more than one encapsulated core 22, said external part including said cholesteric liquid crystal being the wall 21 and said internal part including said thermochromic compound or said photochromic compound being at least one, preferably more than one, of the encapsulated cores 22.

According to a more particular embodiment, in the case of a multicore capsule 20, with reference to FIG. 2a, at least one of the encapsulated cores 22a includes a first thermochromic compound having an activation temperature T1 and at least one other bore 22b comprises a second thermochromic compound having an activation temperature T2, the temperatures T1 and T2 being different.

According to another particular embodiment, in the case of a multicore capsule 20, with reference to FIG. 2a, at least one of the encapsulated cores 22a includes a first photochromic compound having an activation rate V1 and at least one other core 22b comprises a second photochromic compound having an activation rate V2, the rates V1 and V2 being different. Certain photochromic compounds become colored after a few seconds of exposure, for others more time is required.

More generally, according to the invention, said internal part including the liquid crystal and/or the photochromic compound furthermore includes a dye and/or luminescent compounds and/or iridescent pigments. The expression “iridescent pigments” is here understood to mean pigments that cause an optical interference effect (color change depending on the viewing angle and/or the angle of illumination) observable against any background, in contrast to cholesteric liquid crystals the interference effect of which is clearly visible only against a dark background. As iridescent pigments it is possible to use conventional iridescent pigments whose color varies continuously depending on the viewing angle/angle of illumination (iris effect) or iridescent pigments that change between only two colors depending on the viewing angle/angle of illumination, known mica/titanium oxide pigments may be used. The use of a dye and/or iridescent pigments gives a colored and/or iridescent appearance to the security element when the effect of the liquid crystals is “turned off” by making the dark background disappear.

For example, the capsule has a single-core structure 10 and is such that its wall 11 comprises a cholesteric liquid crystal and the encapsulated core 12 includes a thermochromic compound that is black at room temperature and changes from black to colorless at around 31° C., plus a fluorescent compound that is invisible in daylight. If a composition comprising these capsules is coated or printed onto a support, at room temperature the interference effect of the liquid crystals is revealed when observed against a black background. When touched, under the effect of the body's heat, the thermochromic, compound becomes colorless and the interference effect of the liquid crystals disappears. In the case where the capsules are printed and form a text or a pattern, this text or pattern then disappears and advantageously a message hidden beneath the printed capsules may be revealed. In addition, the combined action of touching and UV exposure allows the fluorescent compound, which fluoresces under UV, to be revealed.

According to another example, the capsule 20 has a multicore structure and is such that its wall 21 comprises a cholesteric liquid crystal and one of the encapsulated cores 22a comprises a thermochromic compound that is black at room temperature and that changes from black to colorless at around 31° C., and the other encapsulated core 22b comprises an iridescent pigment. If a composition comprising these capsules is coated or printed onto a support, at room temperature the interference effect of the liquid crystals is observed. When touched, under the effect of the body's heat, the thermochromic compound becomes colorless and only the iridescence of the other core is observed. If a dye is added instead of the iridescent pigment, a colored effect will be observed or, if this dye is added to another core or even to the iridescent pigment, the combination of the two effects, color and iridescence, will be observed under the effect of the body's heat. As a variant, it will be possible to observe fluorescence under UV if a fluorescent compound is added to the encapsulation.

According to another particular embodiment of the invention, with reference to FIG. 3, the capsule 30 comprises an external layer 31 and two concentric internal layers 32, 33, said two internal layers being called E-layer 32 and I-layer 33, the I-layer 33 being the innermost layer, said external part which includes said cholesteric liquid crystal being said external layer 31 and said internal part which includes said thermochromic compound and/or said photochromic compound being at least one of the two internal layers 32, 33.

In particular such a capsule 30 is chosen from dual-walled capsules comprising an external wall forming the external layer 31, an internal wall forming the E-layer 32 and an encapsulated core forming the I-layer 33, and from dual-core capsules comprising a wall forming the external layer 31 and an encapsulated dual core forming the E-layer 32 and the I-layer 33.

According to one particular embodiment of the invention, the capsule 30 has an external wall 31 comprising a cholesteric liquid crystal and one of the internal layers 32, 33 comprises said thermochromic compound and/or said photochromic compound and the other internal layer comprises an iridescent pigment. For example in this case, if the capsule 30 is a dual-walled capsule, and is such that its external wall 31 comprises a cholesteric liquid crystal, and its internal wall 33 comprises a thermochromic compound that is black at room temperature and that changes from black to colorless at around 31° C., and the encapsulated core 33 comprises an iridescent pigment, and a composition comprising these capsules is coated or printed onto a support, at room temperature the interference effect of said liquid crystal is observed, and when touched, under the effect of the body's heat, only the interference effect of the iridescent pigment is observed.

According to another example, the capsule 30 has a dual-walled structure and is such that its external wall 31 comprises a cholesteric liquid crystal, and its internal wall 32 comprises an iridescent pigment, and the encapsulated core 33 comprises a thermochromic compound that is black at room temperature and that changes from black to colorless at around 35° C. If a composition comprising these capsules is coated or printed onto a support, at room temperature the interference effect of the liquid crystal and the interference effect of the iridescent material are observed in combination. When touched, under the effect of the body's heat, the thermochromic compound becomes colorless and only the iridescence is observed.

According to another particular embodiment of the invention, the capsule 30 has an external part 31 that comprises a cholesteric liquid crystal, the E-layer 32 comprises said thermochromic compound and/or said photochromic compound and the I-layer 33 comprises a dark-color dye, preferably a black dye, and either another cholesteric liquid crystal, different from that of the external part, or an iridescent pigment. For example in this case, the capsule 30 has a dual-walled structure and is such that its external wall 31 comprises a cholesteric liquid crystal, and its internal wall 32 comprises a thermochromic compound that is black at room temperature and that changes from black to colorless at around 31° C., and the encapsulated core 33 comprises another cholesteric liquid crystal (different from that of the external wall) and a black dye. If a composition comprising these capsules is coated or printed onto a support, at room temperature the interference effect due only to the liquid crystal of the external wall 31 is observed. When touched, under the effect of the body's heat, the thermochromic compound becomes colorless and an interference effect resulting from the combination of the effect of the liquid crystal of the external wall 31 and the effect of the liquid crystal of the core 33 is observed allowing the black dye to be revealed.

According to another particular embodiment of the invention, the capsule 30 is such that its external part 31 comprises a cholesteric liquid crystal and the E-layer 32 comprises an iridescent pigment and a luminescent compound having a luminescence color 1 and the I-layer 33 comprises said thermochromic compound and a luminescent compound having a luminescence color 2, the luminescence colors 1 and 2 being different. For example, the capsule 30 has a dual-walled structure and is such that its external wall 31 comprises a cholesteric liquid crystal, and its internal wall 32 comprises an iridescent pigment plus a fluorescent compound of color 1 (green), and the encapsulated core comprises a black thermochromic compound that changes from black to colorless at around 35° C. plus a fluorescent compound of color 2 (red). If a composition comprising these capsules is coated or printed onto a support, at room temperature the interference effect of the liquid crystal of the external wall 31 is observed, to which is also added, under UV exposure, the fluorescence color 1 (green). When touched, under the effect of the body's heat, the thermochromic compound clears and only the interference effect of the iridescent pigment is observed, to which is also added, under UV exposure, a fluorescent color (yellow) resulting from the combination of the fluorescent colors 1 (green) and 2 (red).

According to another particular embodiment of the invention, the capsule 30 the external wall 31 of which comprises a cholesteric liquid crystal is such that:

said E-layer 32 comprises a thermochromic compound having an activation temperature T1, which is a dark color at a temperature below T1 and colorless at a temperature above T1; and

said I-layer 33 comprises an iridescent pigment and
either another thermochromic compound having an activation temperature T2, which is colorless at a temperature below T2 and a dark color at a temperature above T2, the activation temperatures T1 and T2 being different,
or a photochromic compound that is colorless in UV-free light and a dark color under specific activation radiation, in particular ultraviolet radiation.

For example, the capsule 30 is such that its external wall 31 comprises a cholesteric liquid crystal, and its internal wall 32 comprises a thermochromic compound that is black at room temperature and that changes from black to colorless at around 31° C., and the encapsulated core 33 comprises a photochromic compound that changes from colorless to black under UV exposure plus an iridescent pigment. If a composition comprising these capsules is coated or printed onto a support, in daylight (or under UV) and at room temperature the interference effect of the liquid crystal is observed. When touched, under the effect of the body's heat, in UV-free light, the thermochromic compound clears and only the interference effect of the iridescent pigment is observed; under UV, the photochromic compound darkens and the interference effect of the liquid crystal and of the iridescent pigment is observed.

According to another particular embodiment of the invention, the capsule 30 is such that its external wall 31 comprises a cholesteric liquid crystal, and such that said E-layer 32 comprises a photochromic compound that is colorless in UV-free light and a dark color under specific activation radiation, in particular ultraviolet radiation, and an iridescent pigment, and a luminescent compound having a luminescence color 1, and such that said I-layer 33 comprises a luminescent compound having a luminescence color 2, the luminescence colors 1 and 2 being different. Under UV exposure, the photochromic compound darkens and thus the interference effect of the liquid crystal and of the iridescent pigment and the luminescence 1 will be seen, the dark color of the photochromic compound hiding the luminescence 2 from view. Without UV (or with a small amount of UV), only the iridescence is seen.

According to another particular embodiment of the invention, the capsule 30 is such that its external wall 31 comprises a cholesteric liquid crystal, said S-layer 32 comprising a thermochromic compound having an activation temperature T1, which is a dark color at a temperature below T1 and colorless at a temperature above T1, and such that said I-layer 33 comprises an iridescent pigment and another thermochromic compound having an activation temperature T2, which is colorless at a temperature below T2 and a dark color at a temperature above T2, the temperature T1 being lower than the temperature T2.

For example, the capsule 30 is such that its external wall 31 comprises a cholesteric liquid crystal, and its internal wall 32 comprises a thermochromic compound that is black at room temperature and that changes from black to colorless at around 29° C. (T1), and the encapsulated core 33 comprises an iridescent pigment and another thermochromic compound that is colorless at room temperature and that becomes black at a temperature greater than 37° C. (T2).

At room temperature, below T1, the interference effect of the liquid crystal is observed. At a temperature of between T1 and T2, the interference effect of the liquid crystal is no longer seen but the iridescence effect is seen (the two thermochromic compounds being transparent) and at a temperature above T2 the thermochromic compound in the core 33 darkens (at T1 it is colorless) and the interference effect of the liquid crystal and the iridescence are seen.

According to one particular embodiment of the invention, said element comprises at least two capsules 30, the external layer 31 of each of which comprises a cholesteric liquid crystal, one capsule having an internal I-layer 33 containing a luminescent compound with a luminescence color 1 and an internal E-layer 32 comprising a thermochromic compound having an activation temperature T1, which is a dark color at a temperature below T1 and colorless at a temperature above T1 and the other capsule having an internal I-layer 33 containing a luminescent compound with a luminescence color 2 and an internal E-layer 32 comprising a thermochromic compound having an activation temperature T2, which is colorless at a temperature below T2 and a dark color at a temperature above T2, the luminescence colors 1 and 2 being different.

For example, in this case certain capsules are such that the thermochromic compound having the temperature T1 changes from black to colorless (type 1 capsules) and other capsules are such that the thermochromic compound having the temperature T2 changes from colorless to black (type 2 capsules) and the temperature T1 is below the temperature T2. At room temperature, below T1, the interference effect of the liquid crystals of the type 1 capsules will be visible, and under UV exposure the fluorescent color 2 of the type 2 capsules will also be visible. At a higher temperature, above T2, the interference effect of the liquid crystal of the type 2 capsules will be visible, and under UV exposure the fluorescent color of the type 1 capsules will also be visible. In the case where the temperature is between T1 and T2, under UV exposure, only the two fluorescences will be seen. In UV-free light no effect is seen: however if the thermochromic compound 1 colors very rapidly, whereas the thermochromic compound 2 takes longer to be bleached, it is possible to see the two liquid crystals during this period of time.

According to another particular embodiment of the invention, said element comprises at least two capsules 30, the external layer 31 of each of which comprises a cholesteric liquid crystal, one capsule having an internal I-layer 33 containing a luminescent compound with a luminescence color 1, and a internal E-layer 32 comprising a thermochromic compound having an activation temperature T1, which is a dark color at a temperature below T1 and colorless at a temperature above T1, and the other capsule 30 having an internal I-layer 33 containing a luminescent compound with a luminescence color 2 and an internal E-layer 32 comprising a thermochromic compound having an activation temperature T2, which is a dark color at a temperature below T2 and colorless at a temperature above T2, the temperatures T1 and T2 being different and the luminescence colors 1 and 2 being different.

For example, in this case certain capsules are such that the thermochromic compound having the activation temperature T1 changes from black to colorless (type 1a capsules) and other capsules are such that the thermochromic compound having the activation temperature T2 changes from black to colorless (type 2a capsules), the temperature T1 being higher than the temperature T2. At a temperature below T2 (and therefore below T1) and under UV exposure, no fluorescent colors will be observed, each thermochromic compound being black, only the interference effects of the liquid crystals of each type of capsule will be observed. At a temperature of between T2 and T1, the thermochromic compounds of the type 2a capsules is colorless and that of the type 1a capsules is black, under UV exposure the fluorescent color 2 of the type 2 capsules and the interference effect of the liquid crystal of the type 1a capsules will be observed. If the temperatures are above T1 (and therefore above T2), the two thermochromic compounds are colorless, the interference effect of each of the capsules will no longer be seen, and under UV exposure a fluorescent color resulting from the fluorescence of each of the capsules will be seen.

The element according to the invention may take the form of an ink including said particles and a transparent/translucent binder or it may take the form of a support comprising said particles on its surface and/or within it, such as a security thread or film, etc.

The invention relates to a security sheet comprising an optically variable region including said optically variable element, as described above.

In particular, said security sheet according to the invention comprises said security element in the form of an imprint or a layer on at least one of its sides or in the form of an element with a support such as a security patch, a security foil (a tape that may extend over part of the sheet or document, generally over its width or length), a security thread or a security strip, flakes, or a security film (or laminate) such as a polyester or polypropylene film or even heat-transferred or laminated (adhesive-coated) polyurethane, possibly having a thickness of between 5 and 50 μm, which optionally (self)destructs when someone tries to tear it off, possibly covering the entire security sheet or document, or a security bag (into which the security sheet or document is inserted). Said element preferably appears at least partially on the surface of said sheet and, in the case of a thread, it is partially inserted into the sheet and may appear in one or more windows (called a window thread).

According to one particular embodiment, said security sheet includes marks (a pattern, printed characters) beneath said optically variable region. These marks may be printed beneath an optically variable imprint or layer or even on the other side of the support when it is an element with a support (patch, foil, thread or strip, film, flakes etc.). These marks therefore form indicia hidden when the thermochromic or photochromic compound is dark and become visible when the compound is colorless.

The security sheet according to the invention may have a fibrous composition based on fibers chosen from cellulose fibers, in particular cotton fibers, and/or natural organic fibers other than cellulose fibers and/or synthetic fibers and/or optionally mineral fibers; preferably said composition comprises at least 50 wt % of cellulosic fibers. The synthetic fibers may for example be polyester and/or polyamide and/or polyethylene fibers.

Said sheet may also be a synthetic-based sheet such as a polyolefin film (for example a Polyart® sheet from Arjobex) or a synthetic sheet or an arrangement of synthetic sheets allowing plastic tickets or other plastic documents (security labels) to be made.

The invention also relates to a security document comprising said security element or said security sheet and may be especially chosen from identity documents, in particular an identity card or a passport, payment means, in particular bank bills or checks, tickets for entrance to cultural or sporting events and/or tickets for travel.

The invention also relates to an article comprising said security element or said sheet and chosen from security packaging, especially for medicinal products, electronic parts, spare parts, perfumes and security labels.

1-25. (canceled)

26. An optically variable security element comprising at least one quasi-spherical particle including at least one external part and at least one internal part, said external part including at least one cholesteric liquid crystal and said internal part including at least one thermochromic compound and/or a photochromic compound that undergoes a reversible transition from a colorless state to a dark color or from a dark color to a colorless state when said compound is subjected, respectively, to an activation temperature or activation radiation, the dark color making it possible to see the interference effect of said liquid crystal and the colorless state making this interference effect no longer visible.

27. The element as claimed in claim 26, wherein the dark color of said thermochromic or photochromic compound has a lightness L* of 37 or less, determined according to the CIE system under illuminant D65 and at a viewing angle of 10 degrees.

28. The element as claimed in claim 26, wherein said particles are capsules or particles obtained from a fluidized bed.

29. The element as claimed in claim 28, wherein said particles have an average size of between 1 and 20 μm.

30. The element as claimed in claim 29, wherein said particles have an average size of between 3 and 10 μm.

31. The element as claimed in claim 26, wherein said thermochromic compound has an activation temperature above 25° C. and is chosen from thermochromic compounds that are a dark color at a temperature below said activation temperature and that are colorless at a temperature above this activation temperature and from thermochromic compounds that are colorless at a temperature below said activation temperature and that are a dark color at a temperature above this activation temperature.

32. The element as claimed in claim 31, wherein the activation temperature is between 25 and 40°.

33. The element as claimed in claim 26, wherein said photochromic compound is chosen from photochromic compounds that are colorless in UV-free light and a dark color under specific activation radiation.

34. The element as claimed in claim 28, wherein said capsule is a single-core capsule comprising a wall and an encapsulated core, said external part including said cholesteric liquid crystal being the wall and said internal part including said thermochromic compound or said photochromic compound being the encapsulated core.

35. The element as claimed in claim 28, wherein the capsule is a multicore capsule comprising a wall and more than one encapsulated core, said external part including said cholesteric liquid crystal being the wall and said internal part including said thermochromic compound or said photochromic compound being at least one of the encapsulated cores.

36. The element as claimed in claim 35, wherein at least one of the encapsulated cores includes a first thermochromic compound having an activation temperature T1 and at least one other core comprises a second thermochromic compound having an activation temperature T2, the temperatures T1 and T2 being different.

37. The element as claimed in claim 35, wherein at least one of the encapsulated cores includes a first photochromic compound having an activation rate V1 and at least one other core comprises a second photochromic compound having an activation rate V2, the rates V1 and V2 being different.

38. The element as claimed in claim 26, wherein said internal part furthermore includes a dye and/or luminescent compounds and/or iridescent pigments.

39. The element as claimed in claim 28, wherein the capsule comprises an external layer and two concentric internal layers, said two internal layers being called E-layer and I-layer, the I-layer being the innermost layer, said external part which includes said cholesteric liquid crystal being said external layer and said internal part which includes said thermochromic compound or said photochromic compound being at least one of the two internal layers.

40. The element as claimed in claim 39, wherein the capsule is chosen from dual-walled capsules comprising an external wall forming the external layer, an internal wall forming the E-layer and an encapsulated core forming the I-layer, and from dual-core capsules comprising a wall forming the external layer and an encapsulated dual-core forming the E-layer and the I-layer.

41. The element as claimed in claim 39, wherein one of the internal layers comprises said thermochromic compound and/or said photochromic compound and the other internal layer comprises an iridescent pigment.

42. The element as claimed in claim 39, wherein the E-layer comprises said thermochromic compound and/or said photochromic compound and the I-layer comprises a dark-color dye, and either another cholesteric liquid crystal, different from that of the external part, or an iridescent pigment.

43. The element as claimed in claim 39, wherein the E-layer comprises an iridescent pigment and a luminescent compound having a luminescence color 1 and the I-layer comprises said thermochromic compound and a luminescent compound having a luminescence color 2, the luminescence colors 1 and 2 being different.

44. The element as claimed in claim 39, wherein:
said E-layer comprises a thermochromic compound having an activation temperature T1, which is a dark color at a temperature below T1 and colorless at a temperature above T1; and
said I-layer comprises an iridescent pigment and
either another thermochromic compound having an activation temperature T2,
which is colorless at a temperature below T2 and a dark color at a temperature above T2, the activation temperatures T1 and T2 being different,
or a photochromic compound that is colorless in UV-free light and a dark color under specific activation radiation.

45. The element as claimed in claim 39, wherein said E-layer comprises a photochromic compound that is colorless in UV-free light and a dark color under specific activation radiation and an iridescent pigment and a luminescent compound having a luminescence color 1, and in that said I-layer comprises a luminescent compound having a luminescence color 2, the luminescence colors 1 and 2 being different.

46. The element as claimed in either of claim 39, wherein its external wall comprises a cholesteric liquid crystal, said E-layer comprising a thermochromic compound having an activation temperature T1, which is a dark color at a temperature below T1 and colorless at a temperature above T1, and in that said I-layer comprises an iridescent pigment and another thermochromic compound having an activation temperature T2, which is colorless at a temperature below T2 and a dark color at a temperature above T2, the temperature T1 being lower than the temperature T2.

47. The element as claimed in claim 39, wherein it comprises at least two capsules, the external layer of each of which comprises a cholesteric liquid crystal, one capsule having an internal I-layer containing a luminescent compound with a luminescence color 1 and a internal E-layer comprising a thermochromic compound having an activation temperature T1, which is a dark color at a temperature below T1 and colorless at a temperature above T1 and the other capsule having an internal I-layer containing a luminescent compound with a luminescence color 2 and an internal E-layer comprising a thermochromic compound having an activation temperature T2, which is colorless at a temperature below T2 and a dark color at a temperature above T2, the luminescence colors 1 and 2 being different.

48. The element as claimed in claim 39, wherein said element comprises at least two capsules the external layer of each of which comprises a cholesteric liquid crystal, one capsule having an internal I-layer containing a luminescent compound with a luminescence color 1, and a internal E-layer comprising a thermochromic compound having an activation temperature T1, which is a dark color at a temperature below T1 and colorless at a temperature above T1, and the other capsule having an internal I-layer containing a luminescent compound with a luminescence color 2 and an internal E-layer comprising a thermochromic compound having an activation temperature T2, which is a dark color at a temperature below T2 and colorless at a temperature above T2, the temperatures T1 and T2 being different and the luminescence colors 1 and 2 being different.

49. A security sheet comprising an optically variable region including said optically variable element as described in claim 26.

50. The security sheet as claimed in claim 49, wherein said security element takes the form of an imprint or a layer on at least one of its sides or the form of an element with a support.

51. The security sheet as claimed in claim 49, wherein it includes marks beneath said optically variable region.

52. A security document comprising said security element as described in claim 1, and chosen from identity documents, payment means, tickets for entrance to cultural or sporting events and/or tickets for travel.

53. An article comprising said security element as described in claim 1 and chosen from security packaging, electronic parts, spare parts, perfumes and security labels.
